(19) United States
(12) Patent Application Publication
(10) Pub. No.: US 2023/0289372 A1
(43) Pub. Date: Sep. 14, 2023

(54) ELECTRONIC MAP UPDATE METHOD AND APPARATUS, ELECTRONIC DEVICE, STORAGE MEDIUM AND PRODUCT

(71) Applicant: BEIJING BAIDU NETCOM SCIENCE TECHNOLOGY CO., LTD., Beijing (CN)

(72) Inventors: Zhixiang CHEN, Beijing (CN); Shaoyi SUN, Beijing (CN); Hailin JIANG, Beijing (CN)

(73) Assignee: BEIJING BAIDU NETCOM SCIENCE TECHNOLOGY CO., LTD., Beijing (CN)

(21) Appl. No.: 17/948,534

(22) Filed: Sep. 20, 2022

(30) Foreign Application Priority Data
Mar. 10, 2022 (CN) 202210240720X

(51) Int. Cl. G06F 16/29; G06F 16/21; G06F 8/658

(52) U.S. Cl. CPC G06F 16/29; G06F 16/219; G06F 8/658

(57) ABSTRACT

An electronic map update method includes: determining an update period of a first electronic map corresponding to a user equipment in response to a map update request sent by the user equipment; determining at least one piece of per-period incremental information currently corresponding to a second electronic map of a latest version; where the per-period incremental information includes an incremental period, the per-period incremental information is a data change record of an electronic map in the incremental period, and the incremental period is a period for starting an incremental conversion of the electronic map; querying, from the at least one piece of per-period incremental information, target incremental information of which a corresponding incremental period is located in the update period; and updating the first electronic map of the user equipment to the second electronic map based on the target incremental information.

### CROSS-REFERENCE TO RELATED APPLICATION

This application claims priority to Chinese Patent Application No. 202210240720.X, filed on Mar. 10, 2022, which is hereby incorporated by reference in its entirety.

### TECHNICAL FIELD

The present disclosure relates to fields such as autonomous driving, intelligent transportation, Internet of Vehicles, and intelligent cockpits in the field of computer technologies, and in particular, to an electronic map update method and apparatus, an electronic device, a storage medium and a product.

### BACKGROUND

An electronic map is a map recorded and stored in a digital form, which can be used in fields such as map navigation, location and information recommendation. The electronic map is mainly composed of multiple pieces of map data, and the map data may include road data, warning signs on roads, speed limit information of roads, connection relationships and the like. In practical applications, the electronic map is constantly updated, and an update of the electronic map is specifically an update of the map data forming the electronic map, for example, adding, deleting, or modifying the map data or other types of updates.

However, since different users may obtain different versions of the electronic map, it is necessary to sequentially update the different versions of the electronic map one by one by using the latest version of the electronic map. A workload of map update is large, resulting in low update efficiency of the electronic map.

### SUMMARY

The present disclosure provides an electronic map update method and apparatus, an electronic device, a storage medium and a product for improving update efficiency of the electronic map.

According to a first aspect of the present disclosure, an electronic map update method is provided, including:
determining an update period of a first electronic map corresponding to a user equipment in response to a map update request sent by the user equipment;
determining at least one piece of per-period incremental information currently corresponding to a second electronic map of a latest version; where the per-period incremental information includes an incremental period; the per-period incremental information is a data change record of an electronic map in the incremental period; and the incremental period is a period for starting an incremental conversion of the electronic map;
querying, from the at least one piece of per-period incremental information, target incremental information of which a corresponding incremental period is located in the update period; and
update the first electronic map of the user equipment to the second electronic map based on the target incremental information.

According to a second aspect of the present disclosure, an electronic map update apparatus is provided, including:
at least one processor; and
a memory communicatively coupled to the at least one processor; where,
the memory stores instructions executable by the at least one processor, and the instructions are executed by the at least one processor to enable the at least one processor to:
determine an update period of a first electronic map corresponding to a user equipment in response to a map update request sent by the user equipment;
determine at least one piece of per-period incremental information currently corresponding to a second electronic map of a latest version; where the per-period incremental information includes an incremental period; the per-period incremental information is a data change record of an electronic map in the incremental period, and the incremental period is a period for starting an incremental conversion of the electronic map;
query, from the at least one piece of per-period incremental information, target incremental information of which a corresponding incremental period is located in the update period; and update the first electronic map of the user equipment to the second electronic map based on the target incremental information.

According to a third aspect of the present disclosure, a non-transitory computer-readable storage medium storing computer instructions is provided, where the computer instructions are used to cause a computer to:
determine an update period of a first electronic map corresponding to a user equipment in response to a map update request sent by the user equipment;
determine at least one piece of per-period incremental information currently corresponding to a second electronic map of a latest version; where the per-period incremental information includes an incremental period; the per-period incremental information is a data change record of an electronic map in the incremental period, and the incremental period is a period for starting an incremental conversion of the electronic map;
query, from the at least one piece of per-period incremental information, target incremental information of which a corresponding incremental period is located in the update period; and
update the first electronic map of the user equipment to the second electronic map based on the target incremental information.

It should be understood that content described in this section is not intended to identify key or critical features of embodiments of the present disclosure, nor is it intended to limit a scope of the present disclosure. Other features of the present disclosure will become readily understood from the following description.

### BRIEF DESCRIPTION OF DRAWINGS

Accompanying drawings are used to better understand the present solution, and do not constitute a limitation to the present disclosure. Where:

FIG. 1 is a schematic diagram of an application scenario applied to an electronic map update method provided by the present disclosure;

FIG. 2 is a flowchart of an embodiment of an electronic map update method provided by an embodiment of the present disclosure;

FIG. 3 is a flowchart of another embodiment of an electronic map update method provided by an embodiment of the present disclosure;

FIG. 4 is a flowchart of yet another embodiment of an electronic map update method provided by an embodiment of the present disclosure;

FIG. 5 is an example diagram of per-period incremental information of a full release version update provided by an embodiment of the present disclosure;

FIG. 6 is an example diagram of per-period incremental information updated according to an incremental period provided by an embodiment of the present disclosure;

FIG. 7 is a flowchart of yet another embodiment of an electronic map update method provided by an embodiment of the present disclosure;

FIG. 8 is a flowchart of yet another embodiment of an electronic map update method provided by an embodiment of the present disclosure;

FIG. 9 is a schematic structural diagram of an embodiment of an electronic map update apparatus provided by an embodiment of the present disclosure; and

FIG. 10 is a block diagram of an electronic device used to implement the electronic map update method according to an embodiment of the present disclosure.

### DESCRIPTION OF EMBODIMENTS

Exemplary embodiments of the present disclosure are described below with reference to accompanying drawings, including various details of the embodiments of the present disclosure to facilitate understanding, which should be considered as exemplary only. Accordingly, those of ordinary skill in the art will recognize that various changes and modifications can be made to the embodiments described herein without departing from the scope and spirit of the present disclosure. Also, descriptions of well-known functions and structures are omitted from the following description for clarity and conciseness.

Technologies according to the present disclosure solves the problem of low update efficiency of the electronic map. The electronic map is incrementally recorded according to a certain period, so that the electronic map is quickly updated according to per-period increments by utilizing incremental changes recorded in different periods.

Technical solutions of the present disclosure can be applied to an update scenario of an electronic map. By calculating increments per period for the electronic map, incremental information of the electronic map in different periods can be recorded, so that when the electronic map is updated, the electronic map can be quickly updated by using the incremental information of respective periods without a need to calculate a map increment for each user, thereby realizing a fast and accurate update of the electronic map.

Generally, the electronic map can be composed of multiple pieces of map data. The map data may include data such as roads, warning signs on the roads, speed limit information of the roads, locations of the roads. That is, a piece of map data may represent a piece of data related to map content in the electronic map. In practical applications, an update of the electronic map is usually an update of the map data in the electronic map, and the update of the map data may mainly include updates such as addition, modification, deletion or other types of updates. For example, “adding speed limit information on road A” is an update of the modification type. The electronic map is actually constantly updated. Operation and maintenance personnel of the electronic map may continuously perform addition, deletion, modification and other operations on the map data of the electronic map, and a database storing the electronic map can be called a map database. When the electronic map needs to be released, the latest version of the electronic map is extracted from the map database to form a release version to release to the public.

At present, when an electronic map is updated, an update request of the electronic map is mostly initiated by users. When an electronic map provider detects the update request sent by a user equipment, a map increment can be calculated based on version data of the electronic map of the user and the latest version of the internal electronic map, to obtain the incremental data of the electronic map, so as to update the electronic map of the user with the incremental data. For example, customer A may receive the electronic map of version 1.2 provided by the provider in February, and customer B may receive the electronic map of version 2.0 provided by the provider in May. Assuming that a current time is in August, the latest electronic map is version 3.0. In order to update the electronic map of different customers to the latest version, it is necessary to calculate the incremental data formed by the map data changed between version 3.0 and version 1.2, and the incremental data formed by the map data changed between version 3.0 and version 2.0. This method of performing the calculation of incremental data for each user separately has a large workload and high work cost. If the number of users is large, then the update efficiency of the electronic map may be low.

In order to solve the above-mentioned technical problem and carry out more effective management to the electronic map, in the present disclosure, it is considered that the electronic map is incrementally recorded according to a certain period, to quickly update the electronic map by utilizing incremental changes recorded in different periods. When a user needs to update, the version of the electronic map of the user is obtained, and an update period corresponding to the electronic map is determined according to a release time of the electronic map of the version and the current time, so as to realize accurate acquisition for the update period of the electronic map. The acquired update period can be used to screen the incremental information to obtain target incremental information belonging to the period, thereby realizing the accurate update of the electronic map.

The present disclosure provides an electronic map update method and apparatus, an electronic device, a storage medium and a product, which can be applied to the fields of autonomous driving, intelligent transportation, Internet of Vehicles and intelligent cockpit in the field of computer technologies, so as to achieve a technical effect of improving the update efficiency of electronic map.

The technical solutions of the present disclosure will be described in detail below in conjunction with the accompanying drawings.

The electronic map may be applied in many fields, such as map navigation, information recommendation and other fields. A provider of the electronic map may provide users with the electronic map. The users may include, for example, business users and individual users. Different users may need to update the electronic map.

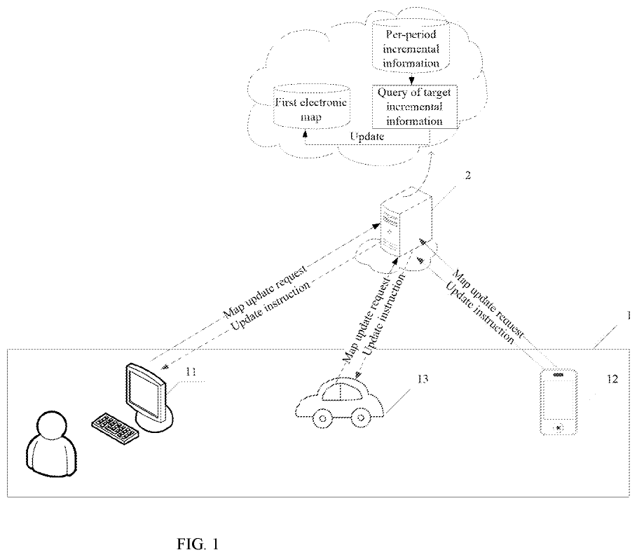

As shown in FIG. 1, which is a schematic diagram of an application scenario applied to an electronic map update method provided by the present disclosure, and this system architecture may include a user equipment 1 and an electronic device 2 for managing an electronic map. The user equipment 1 may be a computer 11, a mobile phone 12, an autonomous vehicle 13, a vehicle-mounted device (not shown in drawings), an internet of vehicles device (not shown in drawings), and the like. The electronic device 2 may be a map server, and the server may be, for example, a common server or a cloud server as shown in FIG. 1. The present disclosure does not impose excessive limitations on specific types of the user equipment or electronic device.

The user equipment 1 may initiate a map update request to the electronic device 2. When the electronic device 2 receives the map update request sent by the user equipment, the electronic map update method of the present disclosure can be used to obtain target incremental information corresponding to the map update request. A first electronic map in the user equipment is updated to a second electronic map based on the target incremental information. By recording the incremental information of the electronic map by periods, the electronic map can be quickly updated according to the incremental information of the periods. For example, an update instruction may be issued to the user equipment based on the target incremental information to improve update efficiency and accuracy of the electronic map.

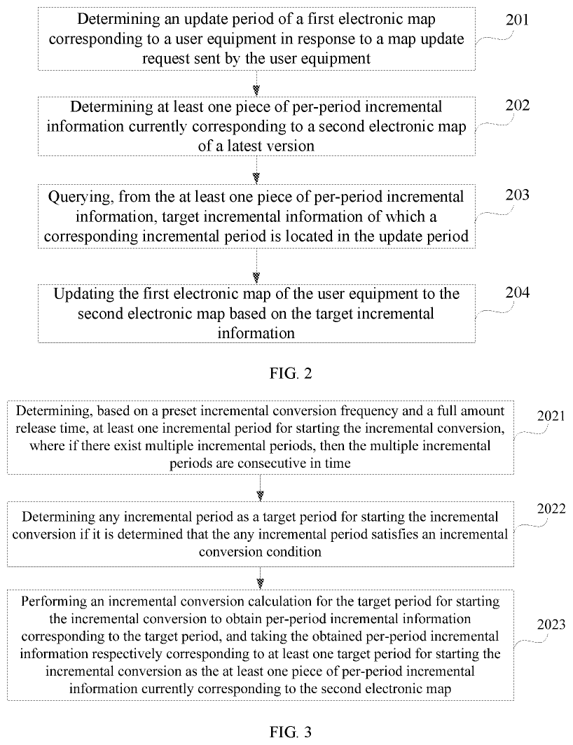

As shown in FIG. 2, it is a flowchart of an embodiment of an electronic map update method provided by an embodiment of the present disclosure. An executive body of the electronic map update method provided by the present embodiment is an electronic map update apparatus, and the electronic map update apparatus is located in an electronic device. The method may include the following steps.
Step 201: determining an update period of a first electronic map corresponding to a user equipment in response to a map update request sent by the user equipment.

The map update request may refer to an update request initiated when the electronic map in the user equipment needs to be updated. The map update request may include map information of the first electronic map corresponding to the user equipment. The map information may include information such as a map name, a map version.

The map update request may be sent by the user equipment or may be generated by the electronic device. The electronic device may generate the map update request for the user equipment when it is determined that the electronic map of the user equipment needs to be updated. The user equipment detects an update operation of the electronic map triggered by the user, generates the map update request for the electronic map, and sends the map update request to the electronic device. Of course, the map update request may also be automatically generated by the electronic device when the electronic device detects that the version of the installed electronic map is too low. The electronic device obtains map information in the map update request, and can query the update period of the corresponding first electronic map according to the map information.
Step 202: determining at least one piece of per-period incremental information currently corresponding to a second electronic map of a latest version, where the per-period incremental information includes an incremental period, the per-period incremental information is a data change record of the electronic map in the incremental period, and the incremental period is a period for starting an incremental conversion of the electronic map.

The per-period incremental information may be obtained by performing the incremental conversion on the second electronic map of the current latest version in the incremental period. The incremental period may be a period formed by respective times corresponding to data of two visions for performing the incremental conversion for the second electronic map of the current latest version. The data change record includes at least one piece of data change information. The data change information is generated by map data recorded using a map element identifier according to a data change type and a data change amount, and the data change information may be an update record of the map data corresponding to the map element identifier.

The data change information may include an addition record of adding a piece of map data, a deletion record of deleting a piece of map data, or a modification record of modifying field information of an attribute field in the map data. The per-period incremental information may include data change information respectively corresponding to at least one map element identifier.

The map database may store the electronic map, and may accept the update of the electronic map by a map management party, specifically the update of the map data of the electronic map, to update the map version of the electronic map constantly. A new version of the electronic map may be generated every time the version in the map database is updated for the electronic map. For example, the map version at 8:00 am is 101, and the map version is constantly updated. Taking an example of updating every half an hour, the map version of the electronic map at 10:00 am is 105. Therefore, in practical applications, the electronic map may include one or more versions. For example, the first electronic map is the electronic map of one version, the second electronic map may be the electronic map of another version, and there are differences between the map data of the two electronic maps.

The at least one piece of per-period incremental information may be sorted in a chronological order. For example, 8:00 to 8:30 may be an incremental period. Assuming that the map version at 8:30 is 102, the per-period incremental information may be calculated from the map version 102 and the map version 101 to obtain the per-period incremental information. After that, an incremental calculation may be performed on the map versions of 8:30 to 9:00, and so on, to obtain the at least one piece of per-period incremental information, where each per-period incremental information may correspond to an incremental period.
Step 203: querying, from the at least one piece of per-period incremental information, target incremental information of which a corresponding incremental period is located in the update period.

The target incremental information may be obtained by querying the at least one piece of per-period incremental information according to a time matching strategy. The time matching strategy may specifically refer to that the incremental period of the target incremental information is in the update period.
Step 204: updating the first electronic map of the user equipment to the second electronic map based on the target incremental information.

Updating the first electronic map of the user equipment to the second electronic map based on the target incremental information may include: generating an update instruction based on the target incremental information, and sending the update instruction to the user equipment. The update instruction may include target map data, which is generated based on the target incremental information and respectively corresponds to the map element identifier. The update instruction controls the user equipment to update the first electronic map to the second electronic map. The user equipment receives the update instruction, and can update the first electronic map to the second electronic map based on the target incremental information in the update instruction. The second electronic map may be the latest version of the electronic map, which may specifically refer to the latest version in the map database, and may be pulled from the map database.

In the embodiment of the present disclosure, by receiving the map update request sent by the user equipment, the update period of the first electronic map of the user equipment can be obtained in response to the request. The update period can be used for obtaining of an increment. Specifically, at least one piece of per-period incremental information currently corresponding to the second electronic map of the latest version may be determined, where the per-period incremental information may include the incremental period. The incremental period may serve as a time constraint on the obtaining of the per-period incremental information to query, from the at least one piece of per-period incremental information, target incremental information of which a corresponding incremental period is located in the update period, thereby realizing accurate acquisition of the incremental information of the first electronic map, so that the first electronic map is updated to the second electronic map based on the target incremental information. The at least one piece of per-period incremental information may be generated along with the update of the electronic map, reflecting the update of the electronic map. By obtaining the target incremental information, the increment of the first electronic map can be accurately obtained, and the update efficiency and accuracy of the electronic map can be improved.

As an embodiment, the determining the update period of the first electronic map corresponding to the user equipment includes:
obtaining a release time of a map version corresponding to the first electronic map provided by the user equipment;
obtaining a generation time of the second electronic map of the latest version; and
determining a period corresponding to the generation time and the release time as the update period of the first electronic map.

When the electronic map is released, a release version number may be set, and the release time of the electronic map may be recorded each time it is released. The release time of the first electronic map can be queried through a map version number corresponding to the first electronic map.

In the embodiment of the present disclosure, when the update period is obtained, the release time of the map version corresponding to the first electronic map provided by the user equipment can be obtained, and meanwhile, the generation time of the second electronic map of the latest version may be obtained, so that the period corresponding to the generation time and the release time is determined as the update period of the first electronic map. By accurately obtaining a generation time interval between the first electronic map and the second electronic map, and using the period corresponding to the time interval as the update period, the update period of the user equipment can be obtained accurately.

As shown in FIG. 3, it is a flowchart of an embodiment of an electronic map update method provided by an embodiment of the present disclosure. An executive body of the electronic map update method provided by the present embodiment is an electronic map update apparatus, and the electronic map update apparatus is located in an electronic device. The difference from FIG. 2 is that step 202 of determining at least one piece of per-period incremental information currently corresponding to the second electronic map of the latest version may specifically include the following steps during execution.
Step 2021: determining at least one incremental period for starting the incremental conversion based on a preset incremental conversion frequency and a full release time; where if there exist multiple incremental periods, then the multiple incremental periods are consecutive in time.
Step 2022: determining any incremental period as a target period for starting the incremental conversion if it is determined that the any incremental period satisfies an incremental conversion condition.
Step 2023: performing an incremental conversion calculation for the target period for starting the incremental conversion to obtain per-period incremental information corresponding to the target period, and taking the obtained per-period incremental information respectively corresponding to at least one target period for starting the incremental conversion as the at least one piece of per-period incremental information currently corresponding to the second electronic map.

Any incremental period satisfying the incremental conversion condition may include: the current time reaching an ending time of the any incremental period. That is, when the current time reaches the ending time of any incremental period, it can be determined that the incremental period satisfies the incremental conversion condition, and the incremental conversion can be started for the incremental period.

In the embodiment of the present disclosure, at least one incremental period for starting the incremental conversion may be determined based on the preset incremental conversion frequency and the full release time. If there exist multiple incremental periods, then the multiple incremental periods are consecutive in time. When any incremental period satisfies the incremental conversion condition, the incremental period can be determined as the target period for starting the incremental conversion. Through obtaining the target period, the increment can be accurately calculated for the electronic map according to a certain time interval. The target period is generated over time, and at least one piece of latest per-period incremental information corresponding to the electronic map can be obtained.

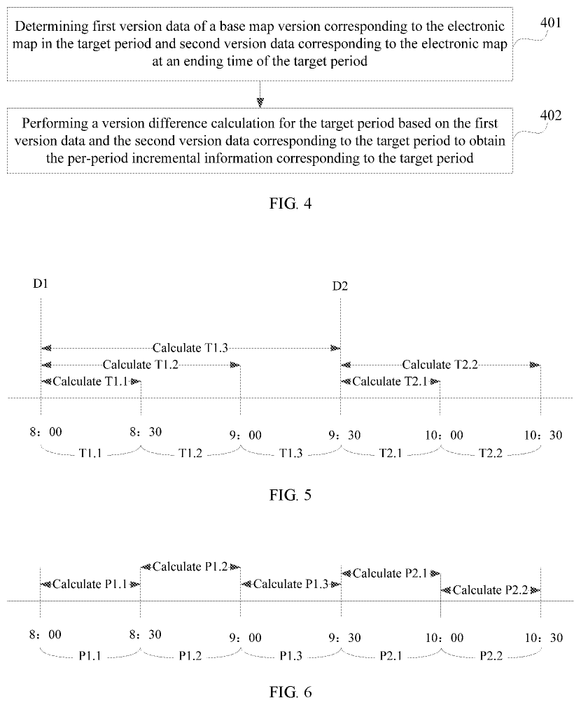

The multiple incremental periods being consecutive in time may refer to that the timelines generated for the multiple incremental periods according to their respective starting times and ending times are continuous without any break in time. The at least one incremental period is determined, and the time will be monitored. If the current time is monitored to reach the ending time of any incremental period, then the incremental period is determined as the target period, and the incremental conversion is started for the target period. The per-period incremental information of the target period may be obtained by specifically executing steps 401 and 402 shown in FIG. 4.

As shown in FIG. 4, in order to carry out an accurate incremental conversion for a target period, the step 2023 of performing the incremental conversion calculation for the target period for starting the incremental conversion to obtain the per-period incremental information corresponding to the target period may specifically include the following steps.
Step 401: determining first version data of a base map version corresponding to the electronic map in the target period and second version data corresponding to the electronic map at an ending time of the target period.
Step 402: performing a version difference calculation for the target period based on the first version data and the second version data corresponding to the target period to obtain the per-period incremental information corresponding to the target period.

There may exist one or more full release times. For each full release, the time of the full release may be recorded. The full release may refer to a release of the electronic map, and each electronic map may have a version number and a release time when it is released. One or more incremental periods may be generated between every two full release times, and each incremental period may be used as a period for starting the incremental conversion of the electronic map.

For ease of understanding, assuming that the full release is at 8:00 a.m. every day, and assuming that the incremental conversion frequency is once every half an hour, then the periods corresponding to the time interval of half an hour, such as 8:00-8:30, 8:30-9:00, 9:00-9:30 and the like can be the incremental period. When each incremental period is taken as the target period to perform the incremental conversion, the second version data corresponding to the electronic map at the ending time of the target period can be obtained. For example, the version data of the electronic map at 8:30, 9:00 and 9:30 is obtained as the second version data corresponding to the target period, respectively.

During the incremental conversion, the version of the electronic map of the latest full release may be used as a base map version to perform the incremental information conversion, or the version of the electronic map of the latest incremental conversion may be used as a base map for to perform the incremental information conversion.

Similarly, taking the above incremental periods as an example, and taking the version of the electronic map of the latest full release as the base map version, the electronic map at 8:00 may be used as the first version data, a difference calculation may performed between the first version data and the second version at 8:30 to obtain the per-period incremental information for 8:00-8:30; the electronic map at 8:00 may be taken as the first version data, and the difference calculation is performed between the first version data and the second version data at 9:00 to obtain the per-period incremental information for 8:30-9:00; and the electronic map at 8:00 is taken as the first version data, and the difference calculation is performed between the first version data and the second version data at 9:30 to obtain the per-period incremental information correspondence to 9:00-9:30.

When an electronic map version of the latest incremental conversion is used as the base map version, the first map data at 8:00 and the second map data at 8:30 may be obtained for comparison to generate the per-period incremental information of 8:00-8:30; the map data at 8:30 and 9:00 are compared to generate the per-period incremental information of 8:30-9:00; and the map data at 9:00 and 9:30 are compared to generate the per-period incremental information of 9:00-9:30.

In the embodiment of the present disclosure, the first version data and the second version data of the electronic map corresponding to the incremental period can be determined, so as to realize the obtaining of the first version data and the second version data corresponding to at least one incremental period, respectively. The first version data and the second version data of any incremental period can be used to calculate a version difference of the incremental period, so as to realize an accurate calculation of the per-period incremental information of the incremental period. Through dividing by period, the per-period incremental information can be calculated for the electronic map in each incremental period in sequence, and changes in the periods can be accurately obtained and controlled for the electronic map.

In order to provide a more detailed description of incremental conversion of the electronic map, take an example where an electronic map version released in full at 8:00 is taken as the base map version.

Referring to FIG. 5, a version of the electronic map of the latest full release is used as a base map version, and the electronic map at 8:00 can be used as first version data D1. In the incremental period of 8:00-8:30, when a current time reaches 8:30, a difference calculation is performed between the first version data and the second version data at 8:30 to obtain per-period incremental information T1.1 of 8:00-8:30. In the incremental period of 8:30-9:00, when the current time reaches 9:00, the difference calculation is performed between the first version data and the second version data at 9:00 to obtain the per-period incremental information T1.2 of 8:30-9:00. In the incremental period of 9:00-9:30, the difference calculation is performed between the first version data and the second version data at 9:30 to obtain the per-period incremental information T1.3 corresponding to 9:00-9:30.

Assuming that the electronic map is released in full again at 9:30, the version data at 9:30 can be used as a new base map version D2. Also taking an example of obtaining the incremental period every half an hour, in the incremental period of 9:30-10:00, the map data at 9:30 can be used as the first version data, and when the current time reaches 10:00, the difference calculation is performed between the first version data and the second version data at 10:00 to obtain the per-period incremental information T2.1 of 9:30-10:00. By analogy, for the incremental period of 10:00-10:30, the map data at 9:30 can be used as the first version data, and when the current time reaches 10:30, the difference calculation is performed between the first version data and the second version data at 10:30 to obtain the per-period incremental information T2.2 of 10:00-10:30.

Referring to FIG. 6, an electronic map version of the latest incremental period is used as a base map version. For the incremental period of 8:00-8:30, when the current time reaches 8:30, the first version data at 8:00 and the second version data at 8:30 can be obtained for difference calculation to obtain the per-period incremental information P1.1 of 8:00-8:30. For the incremental period of 8:30-9:00, when the current time reaches 9:00, the first version data at 8:30 and the second version data at 9:00 can be obtained for difference calculation to obtain the per-period incremental information P1.2 of 8:30-9:00. For the incremental period 9:00-9:30, when the current time reaches 9:30, the first version data at 9:00 and the second version data at 9:30 can be obtained for difference calculation to obtain the per-period incremental information P1.3 of 9:00-9:30.

It is assumed that the electronic map is released in full again at 9:30, and the electronic map version of the latest incremental conversion is used as the base map version. In the incremental period of 9:30-10:00, when the current time reaches 10:00, the difference calculation is performed between the first version data at 9:30 and the second version data at 10:00 to obtain the per-period incremental information P2.1 of 9:30-10:00. By analogy, for the incremental period of 10:00-10:30, when the current time reaches 10:30, the difference calculation can be performed between the map data at 10:00, which is used as the first version data, and the second version data at 10:30 to obtain the per-period incremental information P2.2 of 10:00-10:30.

In a possible design, in order to obtain accurate per-period incremental information, step 402 of performing the version difference calculation for the target period based on the first version data and the second version data corresponding to the target period to obtain the per-period incremental information corresponding to the target period may include:
dividing a map area of the electronic map into at least one sub-area;
determining, from the at least one sub-area, a target sub-area with data change in the target period; and
performing the version difference calculation on the first version data and the second version data corresponding to the target period based on the target sub-area to obtain the per-period incremental information corresponding to the target period.

In an embodiment, the dividing the map area of the electronic map into at least one sub-area may include dividing the map area of the electronic map into at least one sub-area according to a preset area division strategy. The area division strategy may include an area size, an area dividing method and so on. The electronic map can be accurately divided into at least one sub-area through the area division strategy.

In the embodiment of the present disclosure, the map area of the electronic map is divided into at least one sub-area, to determine the target sub-area with data change in the target period from the at least one sub-area, and obtain area data of the target sub-area with data change. Therefore, the version difference calculation is performed on the first version data and the second version data of the target period based on the target sub-area to implement the calculation of the incremental difference at a finer granularity, the obtained per-period incremental information of the target period is more accurate and has higher precision, and difference management is carried out more effectively for the map data of the electronic map by using the area division.

As a mode, the performing the version difference calculation on the first version data and the second version data corresponding to the target period based on the target sub-area to obtain the per-period incremental information corresponding to the target period may include:
obtaining first area data corresponding to the target sub-area in the first version data of the target period and second area data corresponding to the target sub-area in the second version data of the target period;
performing an area increment calculation on the first area data and the second area data of the target sub-area to obtain an area increment of the target period in the target sub-area; and
determining the area increment of the target period in the target sub-area as the per-period incremental information of the target period.

The first area data may be obtained by extracting data from the first version data according to the target sub-area. The second area data may be obtained by extracting data from the second version data according to the target sub-area. The first area data may include at least one piece of first map data, and the second area data may include at least one piece of second map data. Each piece of map data may be recorded using a map element identifier. For ease of understanding, the following table 1 is a data format of a piece of map data recorded using a map element identifier. Each piece of map data may include a map element identifier and one or more attribute fields, and the attribute field may be used to record the map data. For example, the attribute field 1 may record speed limit information of a road, and the attribute field 2 may record sign information of a road.

TABLE 1

| Map element | Attribute | Attribute | Attribute |
|---|---|---|---|
| identifier | field 1 | field 2 | field 3 |
| Id = 123 | A | B | N |

In the embodiment of the present disclosure, the first area data corresponding to the target sub-area in the first version data of the target period and the second area data corresponding to the target sub-area in the second version data of the target period are obtained. An area increment can be calculated by using the first area data and the second area data of the target sub-area, so as to realize obtaining of the area increment of a smaller area. By determining the area increment of the target period in the target sub-area as the per-period incremental information of the target period, accurate acquisition of the per-period incremental information of the target period can be achieved. Through obtaining the first area data and the second area data, the area increment of the target sub-area can be accurately calculated, and the obtaining efficiency and accuracy of the per-period incremental information can be improved.

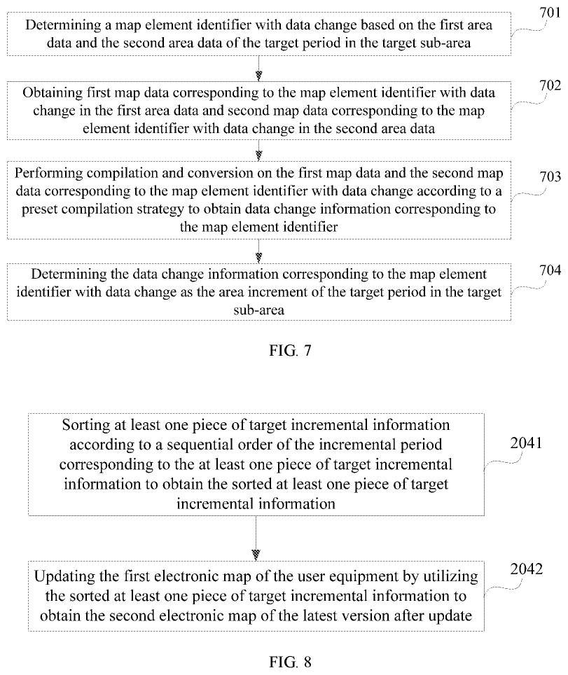

As shown in FIG. 7, it is a flowchart of an embodiment of an electronic map update method provided by the embodiment of the present disclosure. An executive body of the electronic map update method provided by the present embodiment is an electronic map update apparatus, and the electronic map update apparatus is located in an electronic device. On the basis of the electronic map update method provided by the foregoing embodiments, in the embodiment of the present disclosure, the step of performing an area increment calculation on a target sub-area, that is, the performing the area increment calculation on the first area data and the second area data of the target sub-area to obtain the area increment of the target period in the target sub-area may include the following steps.
Step 701: determining a map element identifier with data change based on the first area data and the second area data of the target period in the target sub-area.
Step 702: obtaining first map data corresponding to the map element identifier with data change in the first area data and the second map data corresponding to the map element identifier with data change in the second area data.
Step 703: performing compilation and conversion on the first map data and the second map data corresponding to the map element identifier with data change according to a preset compilation strategy to obtain data change information corresponding to the map element identifier.
Step 704: determining the data change information corresponding to the map element identifier with data change as the area increment of the target period in the target sub-area.

In practical applications, there may exist one or more map element identifiers with data change. The area increment may include the data change information respectively corresponding to at least one map element identifier with data change in the target sub-area.

The area increment calculation is performed on the first area data and the second area data of the target sub-data to obtain the area increment of the target period in the target sub-area, which may include: determining at least one piece of first map data corresponding to the first area data and at least one piece of second map data corresponding to the second area data. The at least one piece of first map data is all map data belonging to the target sub-area in first version data, and the at least one piece of second map data is all map data belonging to the target sub-area in second version data.

Matching of the map element identifier is performed by utilizing the at least one piece of first map data and at least one piece of second map data to obtain the first map data and the second map data with the same map element identifier. If the first map data and the second map data with the same map element identifier are identical, it is determined that there is no data change for the map element identifier; if the first map data and the second map data with the same map element identifier are different, it is determined that the map element identifier has data change.

For any piece of first map data, if the map element identifier of the first map data does not exist in the at least one piece of second map data, then it is determined that the map element identifier of the first map data is the map element identifier with data change.

For any piece of second map data, if the map element identifier of the second map data does not exist in the at least one piece of first map data, it is determined that the map element identifier of the second map data is the map element identifier with data change.

In the above manner, all map element identifiers with data change in the at least one piece of first map data and at least one piece of second map data are obtained.

The preset compilation strategy may refer to determining a data change type and a data change amount of the map element identifier according to a data difference between the first map data and the second map data corresponding to the map element identifier. Through the compilation strategy, the first map data and the second map data of the map element identifier with data change can be used to determine the data change type and the data change amount of the map element identifier according to the data difference to obtain the data change type and the data change amount, and the obtained data change type and data change amount is taken as the data change information corresponding to the map element identifier. The data change type may include addition, deletion, or modification and other types.

For the map element identifier with data change, if neither the first map data nor the second map data of the map element identifier is empty, it can be determined that the data change type is a modification type. If the first map data of the map element identifier is empty, it can be determined that the data change type is an addition type. If the second map data of the map element identifier is empty, it can be determined that the data change type is a deletion type.

After determining the data change type, the data change amount may be determined. The data change amount may include an updated attribute field and an updated content of the attribute field.

For ease of understanding, taking an example where the attribute field 1 in the map data with the ID of 123 in Table 1 is changed to C, composition of the data change information is described in Table 2.

TABLE 2

| Map element | Attribute | Data change | Data change |
|---|---|---|---|
| identifier | field 1 | type | amount |
| ID = 123 | C | Modification | Attribute field 1, |
| | | | changed from A to C |
| ID = 124 | A | Deletion | Deleting map data |
| | | | with ID of 124 |
| ID = 125 | | Addition | Adding map data |
| | | | with ID of 125 |

Referring to Table 2, for the map data with the ID of 123, its attribute field 1 is modified from A to C. For the map data with the ID of 124, the corresponding map data is deleted. For the map data with the ID of 125, the map data with the ID of 125 may be added. Information such as the map element identifier, attribute fields and the like originate from the second map data. The data change type and the data change amount are the specific contents of the data change information.

In the embodiment of the present disclosure, based on the first area data and the second area data of the target period in the target sub-area, at least one map element identifier with data change may be determined. By obtaining the first map data corresponding to the map element identifier in the first area data of the target sub-area and the second map data corresponding to the map element identifier in the second area data of the target sub-area, the first map data and the second map of the map element identifier with change are obtained. The first map data and the second map data may be compiled and converted according to the preset compilation strategy to obtain the data change information corresponding to the map element identifier, so as to obtain the data change information respectively corresponding to at least one map element identifier, and the data change information respectively corresponding to the at least one map element identifiers is the area increment of the target sub-area. Using the map element identifier as the basis for obtaining existing updated data, each piece of map data can be accurately compared, and the obtained area increment of the target sub-area is more accurate, and has higher precision.

In a possible design, step 2022 of determining the first version data of the base map version corresponding to the electronic map in the target period and the second version data corresponding to the electronic map at the ending time of the target period may include the following steps:
determining a previous incremental period of the target period;
obtaining a map version corresponding to the electronic map at an ending time of the previous incremental period as the base map version corresponding to the target period;
reading the first version data corresponding to the base map version from a map database; and
reading the second version data corresponding to the electronic map at the ending time of the target period from the map database.

In practical applications, the time is constantly changing, and a start of the incremental conversion of each incremental period may be started at the ending time of the incremental period. For any incremental period, the map version corresponding to the ending time of the previous incremental period of the incremental period may be used as the base map version of the incremental period. Because the incremental periods are consecutive in time, the ending time of the previous incremental period is the same as the starting time of the following incremental period. When the map version corresponding to the ending time of the previous incremental period is taken as the base map version corresponding to the incremental period, the map data that has changed between the starting time and the ending time of the incremental period can be obtained. Data change can be effectively obtained according to the incremental periods.

In the embodiment of the present disclosure, the previous incremental period of the target period is determined, and the map version corresponding to the electronic map in the previous incremental period is obtained as the base map version corresponding to the target period. Further, the first version data corresponding to the base map version is retrieved from the map database, and the second version data corresponding to the electronic map at the ending time of the target period can also be read from the map database. By obtaining the map version corresponding to the ending time of the previous incremental period of the target period as the base map version, the target period can be used as the basis for obtaining the per-period incremental information, and the increment to the previous version data can be obtained. The period serves as the basis for differential calculation, and there is only one incremental period between the first version data and the second version data. There is less map data that have changed, the calculation amount of the differential calculation is less, and the calculation speed is high.

In yet another possible design, step 2022 of determining the first version data of the base map version corresponding to the electronic map in the target period and the second version data corresponding to the electronic map at the ending time of the target period may include the following steps:
determining the map version corresponding to a third electronic map released in full last before the target period as the base map version;
reading the first version data corresponding to the base map version from the map database; and
reading the second version data corresponding to the electronic map at the ending time of the target period from the map database.

In an embodiment, the release of the electronic map may include a full release and an incremental release. The full release may refer to releasing all map data of the electronic map. The incremental release may refer to releasing only the map data that have changed of the electronic map. The target period may be a period for which the incremental conversion can be started determined by an incremental conversion frequency and a full release time. The incremental conversion for the target period can be started at the ending time of the target period to obtain the per-period incremental information of the target period.

The map version corresponding to the third electronic map released in full last can be used as the base map version to realize the increment calculation of the map data on the basis of a full release version, and the increment can be obtained in a wider range, realizing the accurate acquisition of changed data of the full version.

In the embodiment of the present disclosure, the map version corresponding to the third electronic map which is released in full last before the target period is used as the base map version, and the increment calculation can be performed on the first version data corresponding to the latest full release version and the second version data corresponding to the ending time of the target period, realizing effective comparison between the data of the full release version and the current second version. Using the full release version as the basis for the difference calculation, a more comprehensive difference calculation can be performed on the map data relative to the full release version, so that the map data can be quickly updated directly based on the per-period incremental information of the full release version.

In practical applications, the period between the time when the user initiates the map update request and the time when the latest version of the electronic map is generated may be relatively long. Therefore, one or more pieces of target incremental information may be obtained by querying through the update period. The at least one piece of target incremental information may be merged in sequence according to the incremental period of each piece of target incremental information.

As shown in FIG. 8, it is a flowchart of an embodiment of an electronic map update method provided by an embodiment of the present disclosure. An executive body of the electronic map update method provided by the present embodiment is an electronic map update apparatus, and the electronic map update apparatus is located in an electronic device. A difference between this method and the foregoing embodiments is that, step 204 of updating the first electronic map of the user equipment to the second electronic map based on the target incremental information shown in FIG. 2 may include the following steps.
Step 2041: sorting at least one piece of target incremental information according to a sequential order of the incremental period corresponding to the at least one piece of target incremental information to obtain the sorted at least one piece of target incremental information.
Step 2042: updating the first electronic map of the user equipment by utilizing the sorted at least one piece of target incremental information to obtain the second electronic map of the latest version after update.

The first electronic map of the user equipment is updated with the at least one piece of target incremental information according to the sequential order of the information, and the second electronic map of the latest version can be obtained when the update of the first map data with the last target incremental information finishes.

For ease of understanding, it is assumed that the first electronic map of the user equipment is the electronic map version that is released in full at 8:00 in the above embodiment. The user equipment initiates a map update request at 10:40. Then, the update period corresponding to the user equipment is 8:00-10:40. The at least one incremental period located in the update period includes 8:00-8:30, 8:30-9:00, 9:00-9:30, 9:30-10:00, and 10:00-10:30. The per-period incremental information corresponding to each incremental period is obtained, and the first electronic map is updated by using the obtained 5 pieces of per-period incremental information to obtain the second electronic map of the latest version, i.e., the electronic map corresponding to 10:30. During updating, the electronic map is updated by using the 5 pieces of sorted per-period incremental information sequentially in a chronological order.

In the embodiment of the present disclosure, the at least one piece of target incremental information is sorted according to the sequential order of the corresponding incremental period to obtain the sorted at least one piece of target incremental information, so as to update the first electronic map of the user equipment through utilizing the sorted at least one piece of target incremental information to obtain the second electronic map after update. By sorting the at least one piece of target incremental information according to the sequential order of the corresponding incremental period, it can be ensured that when the first electronic map of the user equipment is updated, the data can be changed in sequence according to the sequential order of the target incremental information, thereby realizing accurate update of the map in a chronological order, avoiding data update errors caused by an inconsistent update order, and improving data update efficiency and accuracy.

In a possible design, the target incremental information includes the data change information corresponding to at least one map element identifier. Steps for obtaining the data change information respectively corresponding to the at least one map element identifier corresponding to the target incremental information have been described in the above embodiments, and are not elaborated here again. Step 2042 of updating the first electronic map of the user equipment by utilizing the sorted at least one piece of target incremental information to obtain the second electronic map after update may include the following steps:
obtaining, in sequence, respective data change information of the at least one map element identifier respectively corresponding to the at least one piece of target incremental information;
dividing the data change information of the same map element identifier in different target incremental information into a group based on the at least one piece of target incremental information to obtain a group of data change information respectively corresponding to the at least one map element identifier; and
updating map data associated with the map element identifier in the first electronic map by utilizing the group of data change information corresponding to the map element identifier to obtain the second electronic map after update of target map data respectively associated with the at least one map element identifier.

Any piece of target incremental information may include data change information respectively corresponding to at least one map element identifier. The map data of the electronic map may be updated according to any piece of target incremental information. The data change information of the same map element identifier in different target incremental information is divided into a group to obtain the group of data change information corresponding to the map element identifier, that is, the group of data change information corresponding to the map element identifier includes at least one piece of data change information.

The map data associated with the element identifier in the first electronic map is updated through utilizing the group of data change information corresponding to the map element identifier, and specifically, the map data associated with the map element identifier in the first electronic map is updated by utilizing the at least one piece of data change information corresponding to the map element identifier.

In the embodiment of the present disclosure, the respective data change information of the at least one map element identifier respectively corresponding to the at least one piece of target incremental information can be obtained in sequence, so as to divide the data change information of the same map element in different target incremental information into a group based on the at least one piece of target incremental information, to obtain the data change information respectively corresponding to at least one map element identifier. It is realized that the map data associated with the map element identifier in the first electronic map is updated by utilizing the group of data change information corresponding to the map element identifier, the map data of the map element identifier is updated, and the map data in the first electronic map is updated accurately, and the second electronic map obtained at the end of the update is more accurate.

As an embodiment, the group of data change information corresponding to the map element identifier includes the at least one piece of data change information associated with the map element identifier; and the updating the map data associated with the map element identifier in the first electronic map by utilizing the group of data change information corresponding to the map element identifier includes:
sorting respective data change information in the group of data change information corresponding to the map element identifier according to an order of corresponding target incremental information to obtain a data order respectively corresponding to the at least one piece of data change information associated with the map element identifier; and
performing merging processing on the map data associated with the map element identifier in the first electronic map in sequence by utilizing the data order respectively corresponding to the at least one piece of data change information to obtain target map data corresponding to the map element identifier.

The sorting of the respective data change information in the group of data change information corresponding to the map element identifier according to the order of the corresponding target incremental information may refer to that, for the at least one piece of data change information in the group of data change information corresponding to the map element identifier, the order of the target incremental information in which any piece of data change information is located may be used as the data order of that piece of data change information, so as to obtain the data order respectively corresponding to the at least one piece of data change information.

In the embodiment of the present disclosure, when the map data associated with the map element identifier in the first electronic map is updated by utilizing the group of data change information corresponding to the map element identifier, the at least one piece of data change information in the group of data change information located at the map element identifier is sorted according to the order of the target incremental information corresponding thereto, and the data order respectively corresponding to the at least one piece of data change information associated with the map element identifier is obtained, so as to update the map data associated with the map element identifier in the first electronic map in sequence by utilizing the data order respectively corresponding to the at least one piece of data change information, and the obtained updated map data is the map data managed by the map element identifier in the second electronic map. An accurate data merging result is obtained by sequentially performing update with the group of data change information of the map element identifier according to the corresponding data order, thereby improving accuracy of data update.

The per-period incremental information may be obtained by performing differential calculation based on the electronic map of the previous incremental period, or may be obtained by performing the differential calculation based on the electronic map of a previous full update. Therefore, based on different differential calculation methods, the update methods of the map data associated with the map element identifier are different.

The map element identifier may be used to obtain an update object, that is, first map data associated with the map element identifier may be an object to be updated. When the map version corresponding to the ending time of the previous incremental period is taken as the base map version, at least one piece of target incremental information can be obtained, and the data of the same map element identifier in respective target incremental information is obtained. And the map data associated with the corresponding map element identifier is updated by utilizing the obtained data of the respective per-period incremental information, to obtain new target map data associated with the map element identifier.

As a first implementation, the per-period incremental information is determined based on the map version corresponding to the ending time of the previous incremental period. The map data associated with the map element identifier in the first electronic map is merged in sequence by utilizing the data order respectively corresponding to the at least one piece of data change information to obtain the target map data corresponding to the map element identifier, which may include:
determining first map data associated with the map element identifier in the first electronic map;
taking the first map data as to-be-updated data of a first piece of data change information;
based on an update strategy of the to-be-updated data corresponding to the data change information, by utilizing the data order corresponding to the at least one piece of data change information, by starting from the first piece of data change information, and by utilizing respective data change information in sequence, performing merging processing on to-be-updated data corresponding to the respective data change information, to obtain a data merging result; where the update strategy includes: taking a data merging result of a previous piece of data change information as to-be-updated data of a following piece of data change information; and
obtaining a data merging result of a last piece of data change information on to-be-updated data corresponding to a last piece of data change information as the target map data of the map element identifier.

When the map version corresponding to the ending time of the previous incremental period is taken as the base map version, the data at the end of each update can be used as an update input for the next piece of data change information to obtain new map data. The update of the map data may be continuously performed with the data change information until the update for the lats piece of data change information is completed.

Referring to FIG. 6, take an example where a full update is performed at 8:00 and a user equipment initiates a map update request at 9:10. The per-period incremental information P1.1 corresponding to the incremental period of 8:00-8:30, and the per-period incremental information P1.2 corresponding to the incremental period of 8:30-9:00 can be obtained.

Assuming that map element identifiers with data change include the ID of 12 to the ID of 17. Data change information corresponding to the ID of 12 to the ID of 17 can be obtained in each piece of per-period incremental information, as shown in Table 3 below:

TABLE 3

| Map element | | | |
|---|---|---|---|
| identifier | P 1.1 | P 1.2 | Result |
| ID = 12 | Modifying | Modifying | Modifying |
| | attribute field | attribute field | attribute field |
| ID = 13 | Modifying | Deleting | Deleting map data |
| | attribute field | | with ID of 13 |
| ID = 14 | Deleting | | Deleting map data |
| | | | with ID of 14 |
| ID = 15 | Deleting | Adding | Adding map data |
| | | | with ID of 15 |
| ID = 16 | Adding | Deleting | No change |
| ID = 17 | Adding | Modifying | Adding ID of 17 |
| | | attribute field | and modifying the |
| | | | attribute field |
| | | | according to P 1.2 |

The first electronic map is updated by utilizing the obtained two pieces of per-period incremental information, where the electronic map is updated by utilizing the sorted two pieces of per-period incremental information in sequence according to a chronological order.

According to the update strategy that a data merging result of a previous piece of data change information is taken as to-be-updated data of a following piece of data change information, respective pieces of data change information are utilized to update their corresponding to-be-updated data in sequence to obtain the data merging result.

Referring to Table 3, it is assumed that the first map data associated with the ID of 12 in the first electronic map is: the attribute field 2 is 80. Then the data change information corresponding to the map element identifier with ID=12 in P1.1 is modifying the attribute field 2 to 50, and the data change information corresponding to that in P1.2 is modifying the attribute field 2 to 100. The attribute field 2 of 80 for the ID of 12 is taken as the to-be-updated data for P1.1, which is updated to 50. After that, the attribute field 2 of 50 can be used as the to-be-updated data for P1.2, and the attribute field 2 is updated from 50 to 100 according to the data change information in P1.2. A final result is to modify the attribute field 2 of the map data with the ID of 12 to 100.

Similarly, for the map data with the ID of 13, an attribute field is modified according to P1.1, and next, the map data of the ID is deleted, and then the obtained result is “deleting map data with ID of 13”. For the map data with the ID of 14, the map data is deleted according to P1.1, the data of the ID is not updated in P1.2, and then the obtained update result is “deleting map data with ID of 14”. For the map data with the ID of 15, the map data is deleted according to P1.1, and next, a piece of map data is newly added to the ID in P1.2, and then the obtained update result is “adding map data with ID of 15”. For the map data with the ID of 16, the map data is added according to P1.1, and next, the map data with the ID of 16 is deleted in P1.2, and then the obtained update result is “Map data with ID of 16 is empty”. For the map data with the ID of 17, a piece of map data is added according to P1.1, and next, an attribute field of the map data with the ID of 17 is modified in P1.2, and then the obtained update result is “adding ID of 17 and modifying the attribute field according to P1.2”.

In the embodiment of the present disclosure, it is possible to determine the first map data associated with the map element identifier in the first electronic map to take the first map data as the to-be-updated data of the first piece of data change information in the at least one piece of data change information, and thereby, according to the update strategy of the to-be-updated data corresponding to the data change information, by utilizing the data order respectively corresponding to the at least one piece of data change information, by starting from the first piece of data change information, and by utilizing each piece of data change information in sequence, update to-be-updated data corresponding to each piece of data change information, to obtain the data merging result. By taking the data merging result of a previous piece of data change information as the to-be-updated data of a following piece of data change information, incremental merging can be performed in a data record level by repeatedly utilizing the update result of a previous piece of data change information. The merging result is more accurate and the obtained target map data is more accurate.

As a second implementation, the per-period incremental information is determined based on the map version corresponding to the third electronic map which is released in full last; and
the performing the merging processing on the map data associated with the map element identifier in the first electronic map in sequence by utilizing the data order respectively corresponding to the at least one piece of data change information to obtain the target map data corresponding to the map element identifier, includes:
updating the first map data associated with the map element identifier in the first electronic map to third map data associated with the map element identifier in the third electronic map;
determining a last piece of data change information after a release time of the third electronic map based on the data order respectively corresponding to the at least one piece of data change information;
performing merging processing on the third map data by utilizing the last piece of data change information to obtain the target map data corresponding to the map element identifier.

If the last piece of data change information after the release time of the third electronic map does not exist, then it is determined that the release time of the third electronic map is the last update, and that the third map data is the target map data corresponding to the map element identifier in the second electronic map.

When the map version of the latest incremental period is used as the base map version, the last piece of data change information corresponding to each base map version can be directly used to update the map data in the base map version.

Referring to FIG. 5, take an example where a full update is performed at 8:00, and a user equipment initiates a map update request at 9:10. The per-period incremental information T1.1 corresponding to the incremental period of 8:00-8:30 and the per-period incremental information T1.2 corresponding to the incremental period of 8:30-9:00 can be obtained.

Assuming that map element identifiers with data change include the ID of 12 to the ID of 17. Data change information corresponding to the ID of 12 to the ID of 17 can be obtained in each piece of per-period incremental information respectively, which is specifically shown in Table 4 below:

TABLE 4

| Map element | | | |
|---|---|---|---|
| identifier | T1.1 | T1.2 | Result |
| ID = 12 | Modifying | Modifying | Modifying |
| | attribute field | attribute field | attribute field |
| | | | (taking T 1.2) |
| ID = 13 | Modifying | Deleting map data | Deleting map data |
| | attribute field | with ID of 13 | with ID 13 |
| ID = 14 | Deleting | | Deleting map data |
| | | | with ID of 14 |
| ID = 15 | Deleting | Adding deleted map | Adding map data |
| | | data with ID of 15 | with ID of 15 |
| ID = 16 | Adding | Deleting added map | Map data with ID |
| | | data with ID of 13 | of 16 is empty |
| ID = 17 | Adding | Modifying added | Adding a piece of |
| | | attribute field 1 | map data with ID |
| | | with ID of 17 to 60 | of17 and setting |
| | | | attribute field 1 |
| | | | as 60 |

The first electronic map is updated by utilizing the obtained two pieces of per-period incremental information, and the two pieces of per-period incremental information are sorted and then utilized in sequence according to a chronological order for updating the electronic map. Also as shown in Table 3, for the map data with ID=12, after the full release at 8:00, its corresponding modifying record in T1.2 is “modifying attribute field”, that is, modifying the attribute field 1 according to T1.2.

Similarly, for the map data with the ID of 13, the map data of the ID can be directly deleted according to the data change information in T1.2, which is “deleting map data with ID of 13”, and the obtained result is “deleting map data with ID of 13”. For the map data with the ID of 14, after the map data is deleted according to T1.1, the record of the ID is “having been deleted” in T1.2, and the obtained update result is “deleting map data with ID of 14”. For the map data with the ID of 15, a piece of map data is added according to “adding deleted map data with ID of 15” in T1.2, then the obtained update result is “adding map data with ID of 15”. For the map data with the ID of 16, the data change information in T1.2 is “deleting added map data with ID of 16”, then it can be directly determined that the map data with the ID of 16 does not exist. For the map data with the ID of 17, the data change information in T1.2 is “modifying added attribute field 1 with the ID of 17 to 60”, a piece of map data with the ID of 17 is added according to the data change information, and the attribute field is modified, then “adding a piece of map data with the ID of 17 and setting attribute field 1 as 60” is obtained.

In the embodiment of the present disclosure, the map data associated with the map element identifier in the first electronic map may be first updated to the third map data associated with the third electronic map, to update the data of the map elements identifier to the map data of the latest full release version. Then, based on the data order corresponding to the at least one piece of data change information, the last piece of data change information can be determined, which is obtained by performing an increment calculation based on the map data of the latest full release version. The third map data can be updated with the last piece of data change information, and then the target map data corresponding to the map element identifier is obtained. Through a full update method, the number of times of data merging is less, which can effectively reduce merging calculation steps and improve the data update efficiency.

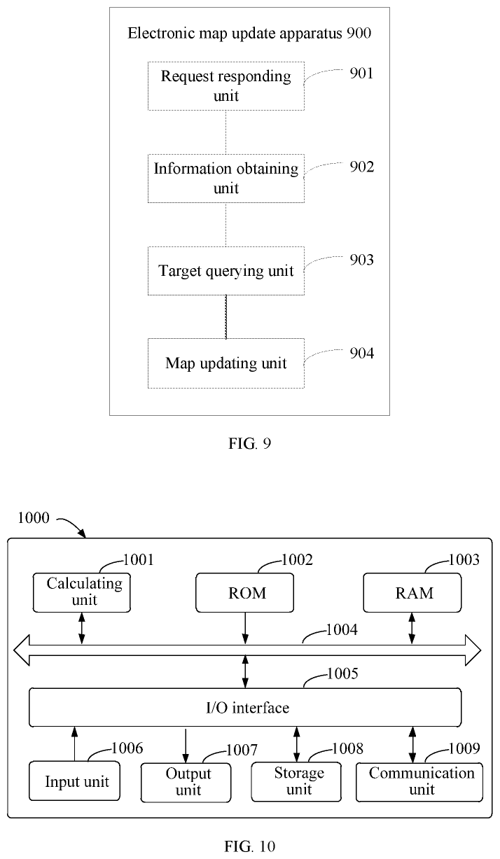

As shown in FIG. 9, which is a schematic structural diagram of an embodiment of an electronic map update apparatus provided by an embodiment of the present disclosure. The electronic map update apparatus provided by this embodiment may be configured with the electronic map update method in the foregoing embodiments, and the electronic map update apparatus is located in an electronic device. The electronic map update apparatus 900 may include the following units:
a request responding unit 901, configured to determine, in response to a map update request sent by a user equipment, an update period corresponding to a first electronic map corresponding to the user equipment;
an information obtaining unit 902, configured to determine at least one piece of per-period incremental information currently corresponding to a second electronic map of a latest version; where the per-period incremental information includes an incremental period; the per-period incremental information is a data change record of an electronic map in the incremental period, and the incremental period is a period for starting an incremental conversion of the electronic map;
a target querying unit 903, configured to query, from the at least one piece of per-period incremental information, target incremental information of which a corresponding incremental period is located in the update period; and
a map updating unit 904, configured to update, based on the target incremental information, the first electronic map of the user equipment to the second electronic map.

As an embodiment, the request responding unit includes:
a first obtaining module, configured to obtain a release time of a map version corresponding to the first electronic map provided by the user equipment;
a second obtaining module, configured to obtain a generation time of the second electronic map of the latest version; and
a first determining module, configured to determine a period corresponding to the generation time and the release time as the update period of the first electronic map.

As yet another embodiment, the information obtaining unit includes:
a second determining module, configured to determine, based on a preset incremental conversion frequency and a full release time, at least one incremental period for starting the incremental conversion; where if there exist multiple incremental periods, then the multiple incremental periods are consecutive in time;
a time determining module, configured to determine any incremental period as the target period for starting the incremental conversion if it is determined that the any incremental period satisfies an incremental conversion condition; and
a conversion starting module, configured to perform an incremental conversion calculation for the target period for starting the incremental conversion to obtain the per-period incremental information corresponding to the target period, and take obtained per-period incremental information respectively corresponding to at least one target period for starting the incremental conversion as the at least one piece of per-period incremental information currently corresponding to the second electronic map.

In some embodiments, the conversion starting module includes:
a data determining submodule, configured to determine first version data of a base map version corresponding to the electronic map in the target period and second version data corresponding to the electronic map at an ending time of the target period; and
an increment calculating submodule, configured to perform a version difference calculation for the target period based on the first version data and the second version data corresponding to the target period to obtain the per-period incremental information corresponding to the target period.

In a possible design, the increment calculating submodule is specifically configured to:
divide a map area of the electronic map into at least one sub-area;
determine, from the at least one sub-area, a target sub-area with data change in the target period; and
perform the version difference calculation on the first version data and the second version data corresponding to the target period based on the target sub-area to obtain the per-period incremental information corresponding to the target period.

In some embodiments, the increment calculating submodule is specifically configured to:
obtain first area data corresponding to the target sub-area in the first version data of the target period and second area data corresponding to the target sub-area in the second version data of the target period;
perform an area increment calculation on the first area data and the second area data of the target sub-area to obtain an area increment of the target period in the target sub-area; and
determine the area increment of the target period in the target sub-area as the per-period incremental information of the target period.

In some embodiments, the increment calculating submodule is specifically configured to:
determine, based on the first area data and the second area data of the target period in the target sub-area, a map element identifier with data change;
obtain first map data corresponding to the map element identifier with data change in the first area data and second map data corresponding to the map element identifier with data change in the second area data;
performing, according to a preset compilation strategy, compilation and conversion on the first map data and the second map data corresponding to the map element identifier with data change to obtain data change information corresponding to the map element identifier; and
determine the data change information corresponding to the map element identifier with data change as the area increment of the target period in the target sub-area.

As an implementation, the data determining submodule is specifically configured to:
determine a previous incremental period of the target period;
obtain a map version corresponding to the electronic map at an ending time of the previous incremental period and taking the obtained map version as the base map version corresponding to the target period;
read, from a map database, the first version data corresponding to the base map version; and
read, from the map database, the second version data corresponding to the electronic map at the ending time of the target period from the map database.

As another implementation, the data determining submodule is specifically configured to:
determine a map version corresponding to a third electronic map which is released in full last before the target period as the base map version;
read, from the map database, the first version data corresponding to the base map version; and
read, from the map database, the second version data corresponding to the electronic map at the ending time of the target period.

As an embodiment, there exists at least one piece of target incremental information; and
the map updating unit includes:
an information sorting module, configured to sort the at least one piece of target incremental information according to a sequential order of the incremental period corresponding to the at least one piece of target incremental information to obtain the sorted at least one piece of target incremental information; and
an information updating module, configured to update the first electronic map of the user equipment by utilizing the sorted at least one piece of target incremental information to obtain the second electronic map of the latest version after update.

In a possible design, the target incremental information includes data change information respectively corresponding to at least one map element identifier; and the information updating module includes:
an identifier data submodule, configured to obtain, in sequence, respective data change information of the at least one map element identifier respectively corresponding to the at least one piece of target incremental information;
a data dividing submodule, configured to divide, based on the at least one piece of target incremental information, the data change information of the same map element identifier in different target incremental information into a group to obtain a group of data change information respectively corresponding to the at least one map element identifier; and
an identifier updating submodule, configured to update map data associated with the map element identifier in the first electronic map by utilizing the group of data change information corresponding to the map element identifier to obtain the second electronic map corresponding to target map data respectively associated with the at least one map element identifier.

In some embodiments, the group of data change information corresponding to the map element identifier includes at least one piece of data change information associated with the map element identifier; and the identifier updating submodule is specifically configured to:
sort respective data change information in the group of data change information corresponding to the map element identifier according to an order of corresponding target incremental information to obtain a data order respectively corresponding to the at least one piece of data change information associated with the map element identifier; and
perform merging processing on the map data associated with the map element identifier in the first electronic map in sequence by utilizing the data order respectively corresponding to the at least one piece of data change information to obtain the target map data corresponding to the map element identifier.

As an implementation, the per-period incremental information is determined based on the map version corresponding to the ending time of the previous incremental period; and the identifier updating submodule is specifically configured to:
determine first map data associated with the map element identifier in the first electronic map;
take the first map data as to-be-updated data of a first piece of data change information;
based on an update strategy of to-be-updated data corresponding to the data change information, by utilizing the data order corresponding to at least one piece of data change information, by starting from the first piece of data change information, and by utilizing respective data change information, perform merging processing on to-be-updated data corresponding to the respective data change information to obtain a data merging result; where the update strategy includes: taking a data merging result of a previous piece of data change information as to-be-updated data of a following piece of data change information; and
obtain a data merging result of a last piece of data change information on to-be-updated data corresponding to a last piece of data change information as the target map data of the map element identifier.

As another implementation, the per-period incremental information is determined based on a map version corresponding to a third electronic map which is released in full last;
the identifier updating submodule is specifically configured to:
update the first map data associated with the map element identifier in the first electronic map to third map data associated with the map element identifier in the third electronic map;
determine, based on the data order respectively corresponding to the at least one piece of data change information, a last piece of data change information after a release time of the third electronic map; and
perform merging processing on the third map data by utilizing the last piece of data change information to obtain the target map data corresponding to the map element identifier.

The electronic map update apparatus of the present disclosure can be used to implement the electronic map update method in the above-mentioned embodiments, and specific content executed by respective units, modules, and sub-modules of the apparatus and technical effects have been described in the relevant embodiments of the method, which will not be elaborated here again.

It should be noted that the user equipment in this embodiment is not aimed at a specific user, and cannot reflect personal information of a specific user.

In technical solutions of the present disclosure, collection, storage, using, processing, transmission, provision and disclosure of the user's personal information involved are all in compliance with relevant laws and regulations, and do not violate public order and good customs.

According to an embodiment of the present disclosure, the present disclosure also provides an electronic device, a readable storage medium and a computer program product.

According to an embodiment of the present disclosure, the present disclosure also provides a computer program product, including a computer program stored in a readable storage medium, and at least one processor of an electronic device can read the computer program from the readable storage medium, and the at least one processor executes the computer program to cause the electronic device to execute the solution provided by any of the foregoing embodiments.

FIG. 10 shows a schematic block diagram of an example electronic device 1000 that may be used to implement embodiments of the present disclosure. The electronic device is intended to represent various forms of digital computers, such as a laptop, a desktop, a work station, a personal digital assistant, a server, a blade server, a mainframe computer, and other suitable computers. The electronic device may also represent various forms of mobile apparatuses, such as a personal digital processor, a cellular phone, a smart phone, a wearable device, and other similar computing apparatuses. The components shown herein, their connections and relationships, and their functions are by way of example only, and are not intended to limit implementations of the disclosure described and/or claimed herein.

As shown in FIG. 10, the electronic device 1000 includes a computing unit 1001, which can perform various appropriate actions and processing according to a computer program stored in a read only memory (ROM) 1002 or a computer program loaded from a storage unit 1008 into a random-access memory (RAM) 1003. In the RAM 1003, various programs and data required for the operation of the device 1000 can also be stored. The computing unit 1001, the ROM 1002 and the RAM 1003 are connected to each other through a bus 1004. An input/output (I/O) interface 1005 is also connected to the bus 1004.

A number of components in the device 1000 are connected to the I/O interface 1005, including: an input unit 1006, such as a keyboard, a mouse; an output unit 1007, such as various types of displays, speakers; a storage unit 1008, such as a disk, an optical disc; and a communication unit 1009, such as a network card, a modem, a wireless communication transceiver. The communication unit 1009 allows the device 1000 to exchange information/data with other devices through a computer network, such as the Internet, and/or various telecommunication networks.

The computing unit 1001 may be various general-purpose and/or special-purpose processing components with processing and computing capabilities. Some examples of the computing unit 1001 include, but are not limited to, a central processing unit (CPU), a graphics processing unit (GPU), various specialized artificial intelligence (AI) computing chips, various computing units that run a machine learning model algorithm, a digital signal processor (DSP), and any suitable processors, controllers, microcontrollers and the like. The computing unit 1001 executes the various methods and processing described above, for example, the electronic map update method. For example, in some embodiments, the electronic map update method may be implemented as a computer software program tangibly embodied on a machine-readable medium, such as the storage unit 1008. In some embodiments, part or all of the computer program may be loaded and/or installed on the device 1000 via the ROM 1002 and/or the communication unit 1009. When the computer program is loaded into the RAM 1003 and executed by the computing unit 1001, one or more steps of the electronic map update method described above may be performed. Alternatively, in other embodiments, the computing unit 1001 may be configured to perform the electronic map update method by any other suitable means (for example, by means of firmware).

Various implementations of systems and techniques described herein above may be implemented in digital electronic circuitry, an integrated circuit system, a field programmable gate array (FPGA), an application specific integrated circuit (ASIC), an application specific standard product (ASSP), a system-on-a-chip (SOC), a complex programmable logic device (CPLD), computer hardware, firmware, software, and/or combinations thereof. These various embodiments may include being implemented in one or more computer programs, and the one or more computer programs can be executed and/or interpreted on a programmable system including at least one programmable processor, the programmable processor may be a special purpose or general-purpose programmable processor, may receive data and instructions from a storage system, at least one input apparatus, and at least one output apparatus, and transmit data and instructions to the storage system, the at least one input apparatus, and the at least one apparatus.

Program code for implementing the methods of the present disclosure may be written in any combination of one or more programming languages. These program codes may be provided to a processor or controller of a general-purpose computer, a special-purpose computer or other programmable data processing apparatus, such that the program code, when executed by the processor or controller, causes the functions/functions specified in the flowcharts and/or block diagrams to be implemented. The program code may be executed entirely on a machine, partly on a machine, partly on the machine and partly on a remote machine as stand-alone software packages, or entirely on a remote machine or server.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. The machine-readable media may include, but are not limited to, an electronic, magnetic, optical, electromagnetic, infrared, or semiconductor system, device, or device, or any suitable combination of the foregoing. More specific examples of the machine-readable storage media would include an electrical connection based on one or more wires, a portable computer disk, a hard disk, a random access memory (RAM), a read only memory (ROM), an erasable programmable read only memory (EPROM or flash memory), an optical fiber, a compact disk read only memory (CD-ROM), an optical storage device, a magnetic storage device, or any suitable combination of the foregoing.

To provide interaction with a user, the systems and techniques described herein may be implemented on a computer, and the computer includes a display device (for example, a CRT (cathode ray tube) or an LCD (liquid crystal display) monitor) for displaying information to a user; and a keyboard and a pointing device (for example, a mouse or trackball) through which a user can provide input to the computer. Other kinds of apparatus may also be used to provide interaction with the user; for example, feedback provided to the user may be sensory feedback in any form (for example, visual feedback, auditory feedback, or tactile feedback); and input from the user may be received in any form (including acoustic input, voice input, or tactile input).

The systems and techniques described herein may be implemented on a computing system including a back-end component (for example, as a data server), or a computing system including a middleware component (for example, an application server), or a computing system including a front-end components (for example, a user computer having a graphical user interface or web browser through which a user may interact with implementations of the systems and techniques described herein), or a computing system including any combination of such back-end component, intermediate component, or front-end component. The components of the system may be interconnected by any form or medium of digital data communication (for example, a communication network). Examples of the communication network include: a local area network (LAN), a wide area network (WAN), and the Internet.

A computer system may include a client and a server. The client and server are generally remote from each other and usually interact through a communication network. A relationship between the client and server is generated by running computer programs having a client-server relationship to each other on respective computers. The server may be a cloud server, also known as a cloud computing server or a cloud host, which is a host product in the cloud computing service system to solve the defects of difficult management and weak business scalability existing in traditional physical hosts and VPS services (“Virtual Private Server”, or “VPS” for short). The server may also be a server of a distributed system, or a server combined with a blockchain.

It should be understood that steps may be reordered, added or deleted using the various forms of flows shown above. For example, the steps described in the present disclosure may be executed in parallel, sequentially, or in different orders, as long as desired results of the technical solutions disclosed in the present disclosure can be achieved, which is not limited herein.

The above-mentioned specific embodiments do not constitute a limitation to a protection scope of the present disclosure. It should be understood by those skilled in the art that various modifications, combinations, sub-combinations and substitutions may be made depending on design requirements and other factors. Any modifications, equivalent replacements, and improvements made within a spirit and principle of the present disclosure should be included within the protection scope of the present disclosure.

What is claimed is:

1. An electronic map update method, comprising:
determining an update period of a first electronic map corresponding to the user equipment in response to a map update request sent by the user equipment;
determining at least one piece of per-period incremental information currently corresponding to a second electronic map of a latest version; wherein the per-period incremental information comprises an incremental period, the per-period incremental information is a data change record of an electronic map in the incremental period, and the incremental period is a period for starting an incremental conversion of the electronic map;
querying, from the at least one piece of per-period incremental information, target incremental information of which a corresponding incremental period is located in the update period; and
updating, based on the target incremental information, the first electronic map of the user equipment to the second electronic map.

2. The method according to claim 1, wherein the determining the update period of the first electronic map corresponding to the user equipment comprises:
obtaining a release time of a map version corresponding to the first electronic map provided by the user equipment;
obtaining a generation time of the second electronic map of the latest version; and
determining a period corresponding to the generation time and the release time as the update period of the first electronic map.

3. The method according to claim 1, wherein the determining at least one piece of per-period incremental information currently corresponding to the second electronic map of the latest version comprises:
determining at least one incremental period for starting the incremental conversion based on a preset incremental conversion frequency and a full release time; wherein if there exist multiple incremental periods, then the multiple incremental periods are consecutive in time;
determining any incremental period as a target period for starting the incremental conversion if it is determined that the any incremental period satisfies an incremental conversion condition; and
performing an incremental conversion calculation for the target period for starting the incremental conversion to obtain the per-period incremental information corresponding to the target period, and taking the obtained per-period incremental information respectively corresponding to at least one target period for starting the incremental conversion as the at least one piece of per-period incremental information currently corresponding to the second electronic map of the latest version.

4. The method according to claim 3, wherein the performing the incremental conversion calculation on the target period for starting the incremental conversion to obtain the per-period incremental information corresponding to the target period, comprises:
determining first version data of a base map version corresponding to the electronic map in the target period, and second version data corresponding to the electronic map at an ending time of the target period; and
performing a version difference calculation for the target period based on the first version data and the second version data corresponding to the target period to obtain the per-period incremental information corresponding to the target period.

5. The method according to claim 4, wherein the performing the version difference calculation for the target period based on the first version data and the second version data corresponding to the target period to obtain the per-period incremental information corresponding to the target period comprises:
dividing a map area of the electronic map into at least one sub-area;
determining, from the at least one sub-area, a target sub-area with data change in the target period; and
performing the version difference calculation on the first version data and the second version data corresponding to the target period based on the target sub-area to obtain the per-period incremental information corresponding to the target period.

6. The method according to claim 5, wherein the performing the version difference calculation on the first version data and the second version data corresponding to the target period based on the target sub-area to obtain the per-period incremental information corresponding to the target period comprises:
obtaining first area data corresponding to the target sub-area in the first version data of the target period, and second area data corresponding to the target sub-area in the second version data of the target period;
performing an area increment calculation on the first area data and the second area data of the target sub-area to obtain an area increment of the target period in the target sub-area; and
determining the area increment of the target period in the target sub-area as the per-period incremental information of the target period.

7. The method according to claim 6, wherein the performing the area increment calculation on the first area data and the second area data of the target sub-area to obtain the area increment of the target period in the target sub-area comprises:
determining, based on the first area data and the second area data of the target period in the target sub-area, a map element identifier with data change;
obtaining first map data corresponding to the map element identifier with data change in the first area data and second map data corresponding to the map element identifier with data change in the second area data;
performing, according to a preset compilation strategy, compilation and conversion on the first map data and the second map data corresponding to the map element identifier with data change to obtain data change information corresponding to the map element identifier; and
determining the data change information corresponding to the map element identifier with data change as the area increment of the target period in the target sub-area.

8. The method according to claim 4, wherein the determining the first version data of the base map version corresponding to the electronic map in the target period and the second version data corresponding to the electronic map at the ending time of the target period comprises:
determining a previous incremental period of the target period;
obtaining a map version corresponding to the electronic map at an ending time of the previous incremental period and taking the obtained map version as the base map version corresponding to the target period;
reading, from a map database, the first version data corresponding to the base map version; and
reading, from the map database, the second version data corresponding to the electronic map at the ending time of the target period.

9. The method according to claim 4, wherein the determining the first version data of the base map version corresponding to the electronic map in the target period and the second version data corresponding to the electronic map at the ending time of the target period comprises:
determining a map version corresponding to a third electronic map released in full last before the target period as the base map version;
reading, from a map database, the first version data corresponding to the base map version;
reading, from the map database, the second version data corresponding to the electronic map at the ending time of the target period.

10. The method according to claim 1, wherein there exists at least one piece of target incremental information; and
the updating, based on the target incremental information, the first electronic map of the user equipment to the second electronic map comprises:
sorting the at least one piece of target incremental information according to a sequential order of the incremental period corresponding to the at least one piece of target incremental information to obtain the sorted at least one piece of target incremental information; and
updating the first electronic map of the user equipment by utilizing the sorted at least one piece of target incremental information to obtain the second electronic map of the latest version after update.

11. The method according to claim 10, wherein the target incremental information comprises data change information respectively corresponding to at least one map element identifier; the updating the first electronic map of the user equipment by utilizing the sorted at least one piece of target incremental information to obtain the second electronic map of the latest version after update comprises:
obtaining, in sequence, respective data change information of the at least one map element identifier respectively corresponding to the at least one piece of target incremental information;
dividing, based on the at least one piece of the target incremental information, the data change information of the same map element identifier in different target incremental information into a group to obtain a group of data change information respectively corresponding to the at least one map element identifier; and
updating map data associated with the map element identifier in the first electronic map by utilizing the group of data change information corresponding to the map element identifier to obtain the second electronic map corresponding to target map data respectively associated with the at least one map element identifier.

12. The method according to claim 11, wherein the group of data change information corresponding to the map element identifier comprises at least one piece of data change information associated with the map element identifier; and the updating the map data associated with the map element identifier in the first electronic map by utilizing the group of data change information corresponding to the map element identifier comprises:
sorting respective data change information in the group of data change information corresponding to the map element identifier according to an order of corresponding target incremental information to obtain a data order respectively corresponding to the at least one piece of data change information associated with the map element identifier; and
performing merging processing on the map data associated with the map element identifier in the first electronic map in sequence by utilizing the data order respectively corresponding to the at least one piece of data change information, to obtain the target map data corresponding to the map element identifier.

13. The method according to claim 12, wherein the per-period incremental information is determined based on a map version corresponding to an ending time of a previous incremental period; and the performing merging processing on the map data associated with the map element identifiers in the first electronic map in sequence by utilizing the data order respectively corresponding to the at least one piece of data change information to obtain the target map data corresponding to the map element identifier comprises:
determining first map data associated with the map element identifier in the first electronic map;
taking the first map data as to-be-updated data of a first piece of data change information;
performing, based on an update strategy of the to-be-updated data corresponding to the data change information, by utilizing the data order corresponding to the at least one piece of data change information, by starting from the first piece of data change information, and by utilizing respective data change information, merging processing on to-be-updated data corresponding to the respective data change information to obtain a data merging result; wherein the update strategy comprises: taking a data merging result of a previous piece of data change information as to-be-updated data of a next piece of data change information; and
obtaining a data merging result of a last piece of data change information on to-be-updated data corresponding to the last piece of data change information as the target map data of the map element identifier.

14. The method according to claim 13, wherein the per-period incremental information is determined based on a map version corresponding to a third electronic map released in full last;
the performing merging processing on the map data associated with the map element identifier in the first electronic map in sequence by utilizing the data order respectively corresponding to the at least one piece of data change information to obtain the target map data corresponding to the map element identifier comprises:
updating the first map data associated with the map element identifier in the first electronic map to third map data associated with the map element identifier in the third electronic map;
determining, based on the data order respectively corresponding to the at least one piece of data change information, a last piece of data change information after a release time of the third electronic map; and
performing merging processing on the third map data by utilizing the last piece of data change information to obtain the target map data corresponding to the map element identifier.

15. An electronic map update apparatus, comprising:
at least one processor; and
a memory communicatively coupled to the at least one processor; wherein,
the memory stores instructions executable by the at least one processor, and the instructions are executed by the at least one processor to cause the at least one processor to:
determine an update period of a first electronic map corresponding to a user equipment in response to a map update request sent by the user equipment;
determine at least one piece of per-period incremental information currently corresponding to a second electronic map of a latest version; wherein the per-period incremental information comprises an incremental period; the per-period incremental information is a data change record of an electronic map in the incremental period, and the incremental period is a period for starting an incremental conversion of the electronic map;
query, from the at least one piece of per-period incremental information, target incremental information of which a corresponding incremental period is located in the update period; and
update, based on the target incremental information, the first electronic map of the user equipment to the second electronic map.

16. The apparatus according to claim 15, wherein the at least one processor is further caused to:
obtain a release time of a map version corresponding to the first electronic map provided by the user equipment;
obtain a generation time of the second electronic map of the latest version; and
determine a period corresponding to the generation time and the release time as the update period of the first electronic map.

17. The apparatus according to claim 15, wherein the at least one processor is further caused to:
determine, based on a preset incremental conversion frequency and a full release time, at least one incremental period for starting the incremental conversion; wherein if there exist multiple incremental periods, then the multiple incremental periods are consecutive in time;
determine any incremental period as a target period for starting the incremental conversion if it is determined that the any incremental period satisfies an incremental conversion condition;
perform an incremental conversion calculation for the target period for starting the incremental conversion to obtain the per-period incremental information corresponding to the target period, and take the obtained per-period incremental information respectively corresponding to at least one target period for starting the incremental conversion as the at least one piece of per-period incremental information currently corresponding to the second electronic map of the latest version.

18. The apparatus according to claim 17, wherein the at least one processor is further caused to:
determine first version data of a base map version corresponding to the electronic map in the target period, and second version data corresponding to the electronic map at an ending time of the target period;
perform a version difference calculation for the target period based on the first version data and the second version data corresponding to the target period to obtain the per-period incremental information corresponding to the target period.

19. The apparatus according to claim 18, wherein the at least one processor is further caused to:
divide a map area of the electronic map into at least one sub-area;
determine, from the at least one sub-area, a target sub-area with data change in the target period; and
perform the version difference calculation on the first version data and the second version data corresponding to the target period based on the target sub-area to obtain the per-period incremental information corresponding to the target period.

20. A non-transitory computer-readable storage medium, storing computer instructions, wherein the computer instructions are used to cause a computer to:
determine an update period of a first electronic map corresponding to a user equipment in response to a map update request sent by the user equipment;
determine at least one piece of per-period incremental information currently corresponding to a second electronic map of a latest version; wherein the per-period incremental information comprises an incremental period; the per-period incremental information is a data change record of an electronic map in the incremental period, and the incremental period is a period for starting an incremental conversion of the electronic map;
query, from the at least one piece of per-period incremental information, target incremental information of which a corresponding incremental period is located in the update period; and
update, based on the target incremental information, the first electronic map of the user equipment to the second electronic map.
